(19) United States
(12) Patent Application Publication
(10) Pub. No.: US 2008/0134339 A1
(43) Pub. Date: Jun. 5, 2008

(54) APPARATUS AND METHOD FOR DETECTING ATTACK PACKET IN IPv6

(76) Inventors: Hwan Kuk KIM, Daejeon (KR); Bo Heung Chung, Daejeon (KR); Jae Deok Lim, Daejeon (KR); Young Ho Kim, Daejeon (KR); Seung Ho Ryu, Seoul (KR); Ki Young Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/944,479

(22) Filed: Nov. 23, 2007

(30) Foreign Application Priority Data
Dec. 4, 2006 (KR) 10-2006-0121834

(51) Int. Cl. G06F 21/00

(52) U.S. Cl. 726/25

(57) ABSTRACT

An apparatus and method for detecting an attack packet in Internet Protocol version 6 (IPv6) are provided. The apparatus includes a control unit, a preprocessing unit, an attack determining unit, and a packet processing unit. The control unit sets a rule for attack determination and a rule for processing of an attack packet. The preprocessing unit decodes an IPv6 packet and a tunneling packet, and divides the decoded packet into each header and payload. The attack determining unit determines possibility of attack of the divided packet according to the rule for attack determination by using information of the divided packet. The packet processing unit performs at least one function of packet filtering, packet deleting, packet forwarding, and intrusion alarming according to a result of the determination of the attack determining unit, and the rule for processing of an attack packet.

### CROSS-REFERENCE TO RELATED APPLICATIONS

This application claims the priority of Korean Patent Application No. 10-2006-121834, filed on Dec. 4, 2006, in the Korean Intellectual Property Office, the disclosure of which is incorporated herein by reference.

### BACKGROUND OF THE INVENTION

1. Field of the Invention

The present invention relates to an apparatus and method for detecting an attack packet in Internet Protocol version 6 (IPv6), and more particularly to an apparatus and method for detecting an attack packet in IPv6, which is configured to detect and cope with an attack or intrusion of an IPv6 packet.

This work was supported by the IT R&D program of MIC/IITA [2005-S-402-02, The Development of the High Performance Network Security System]

2. Description of the Related Art

IPv6 is a next generation Internet protocol, which has new features such as extension of an IP address space, simplification of a basic header format, improvement of an extension header structure, enhancement of Internet control message protocol version 6 (ICMPv6), neighbor discovery protocol (NDP), and automatic address configuration. Recently, network devices such as routers and switches that support the IPv6 environment are being emerged, increasing needs for technologies that serve to detect and handle an attack packet in IPv6. However, because main focus has been on the design of intrusion detecting and handling technologies suitable for an IPv4 environment, it is difficult to detect and handle a network attack of a packet based on an IPv6 protocol specification.

### SUMMARY OF THE INVENTION

An aspect of the present invention provides an apparatus and method for detecting an attack packet in IPv6, which is configured to detect and cope with an intrusion on the basis of features of an IPv6 packet and an IPv4/IPv6 tunneling packet.

According to an aspect of the present invention, there is provided an apparatus for detecting an attack packet in Internet Protocol version 6 (IPv6), including: a control unit configured to set a rule for attack determination and a rule for processing of an attack packet; a preprocessing unit configured to decode an IPv6 packet and a tunneling packet, and divide the decoded packet into each header and payload; an attack determining unit configured to determine possibility of attack of the divided packet according to the rule for attack determination by using information of the divided packet, the rule being set at the control unit; and a packet processing unit configured to perform at least one function of packet filtering, packet deleting, packet forwarding, and intrusion alarming according to a result of the determination of the attack determining unit, and the rule for processing of an attack packet, the rule being set at the control unit.

The apparatus for detecting an attack packet in IPv6 may further include a traffic information storage unit configured to store traffic information of a packet determined as an attack packet, so that the control unit can control the attack determining unit and the packet processing unit with reference to the information stored in the traffic information storage unit.

According to another aspect of the present invention, there is provided a method for detecting an attack packet in Internet Protocol version 6 (IPv6), including: setting a rule for attack determination, and a rule for processing of an attack packet; decoding an IPv6 packet and a tunneling packet; dividing the decoded packet into payload and each header; determining possibility of attack of the divided packet according to the rule for attack determination by using information of the divided packet; and performing at least one function of packet filtering, packet deleting, packet forwarding, and intrusion alarming according to a result of the determining of the possibility of attack and the set rule for processing an attack packet.

The method for detecting an attack packet in IPv6 may further include storing traffic information when it is determined that the corresponding packet has the possibility of attack, so that the traffic information can be used in the setting of the rule for attack determination and the rule for processing of an attack packet.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view showing a basic configuration of an apparatus for detecting an attack packet in IPv6 according to an embodiment of the present invention;

FIG. 2 is flowchart of a method for detecting an attack packet in IPv6 according to an embodiment of the present invention;

FIG. 3 is a view showing a configuration of a preprocessing unit of an apparatus for detecting an attack packet in IPv6 according to an embodiment of the present invention;

FIG. 4 is a view showing a configuration of an attack determining unit of an apparatus for detecting an attack packet in IPv6 according to an embodiment of the present invention; and

FIG. 5 is a view showing a configuration of a control unit of an apparatus for detecting an attack packet in IPv6 according to an embodiment of the present invention.

### DETAILED DESCRIPTION OF THE PREFERRED EMBODIMENT

Exemplary embodiments of the present invention that would be easily embodied by those of ordinary skill in the art will now be described in detail with reference to the accompanying drawings. However, in detailed description of operational principle according to the exemplary embodiments, well-known functions, well-known structures will not be described in detail to avoid ambiguous interpretation of the present invention. Also, like reference numerals are used for like elements throughout the specification.

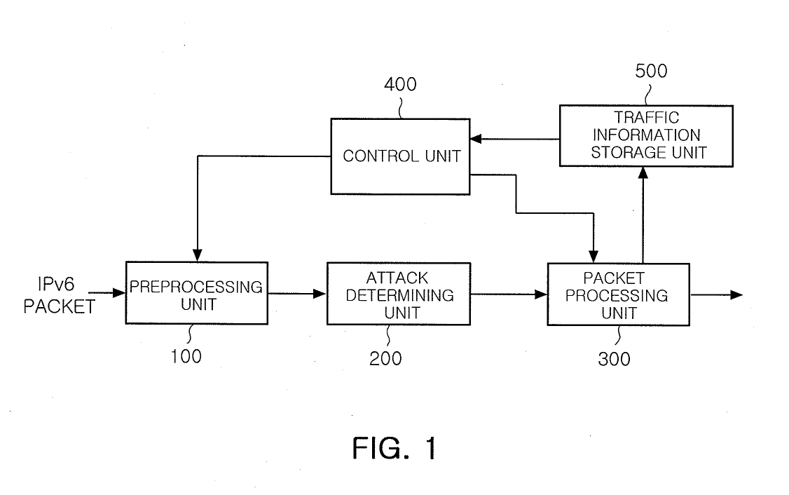

FIG. 1 is a view showing a basic configuration of an apparatus for detecting an attack packet in IPv6 according to an embodiment of the present invention. Referring to FIG. 1, the apparatus for detecting an attack packet in IPv6 includes a preprocessing unit 100, an attack determining unit 200, a packet processing unit 300, and a control unit 400. Also, the apparatus may further include a traffic information storage unit 500 for storing information of an attack packet.

The preprocessing unit 100 collects and decodes an IPv6 packet and a tunneling packet, and divides the decoded IPv6 packet into payload and each header. Thereafter, the preprocessing unit 100 transmits the divided packet to the attack determining unit 200.

The attack determining unit 200 determines whether the divided packet from the preprocessing unit 100 have a feature of an attack packet.

When the attack determining unit determines that the divided packet is an attack packet, the packet processing unit 300 filters and/or deletes the packet, and associated traffic information may be transmitted and stored in the traffic information storage unit 500 so that another packet with the same feature can be quickly detected and handled. Also, to properly cope with the attack packet, an intrusion alarm is generated to report an attack to a security system or a manager employing the present invention. In contrast, if it is determined that the packet is not an attack packet, the corresponding packet is forwarded.

The control unit 400 controls operations of the attack determining unit 200 or the packet processing unit 300. That is, the control unit 400 determines which occasion a packet is classified as one that has possibility of attack, and how to process a packet with possibility of attack and a packet with none. Here, the control unit 400 can control operations of the attack determining unit 200 and the packet processing unit 300 by using the traffic information of the attack packet, which is stored in the traffic information storage unit 500.

An operation of each element will now be described in more detail.

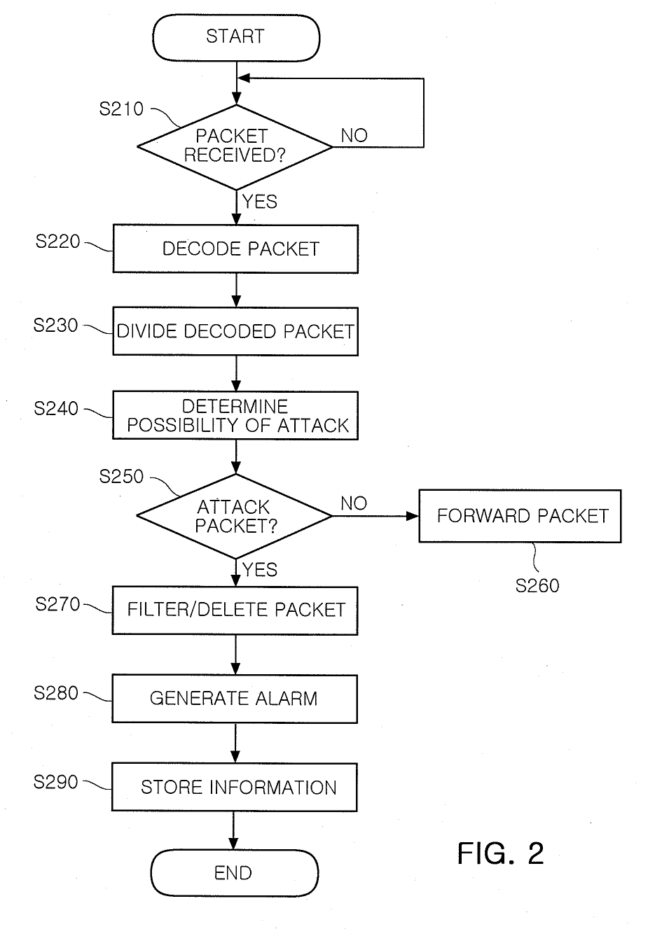

FIG. 2 is a flowchart of a method for detecting an attack packet in IPv6 according to an embodiment of the present invention. When an IPv6 packet and/or a tunneling packet is received in operation S210, the IPv6 packet and/or the tunneling packet is decoded in operation S220. The decoding may be performed through decomposing based on a standard protocol defined in request for comments (RFC). In operation S230, the decoded IPv6 packet is divided into payload and each header. In operation S240, it is determined whether the decoded tunneling packet and the divided IPv6 packet have possibility of attack. If it is determined that the packet has no possibility of attack in operation S250, the packet is forwarded in operation S260, whereas if it is determined that the packet has possibility of attack in operation S250, the packet is filtered or deleted in operation s270. In operation S280, an attack alarm is generated and is transmitted such that a security system or manager employing the present invention can properly cope with the attack. In operation S290, traffic information of the packet having possibility of attack is stored, and is used for intrusion detection of the next packet.

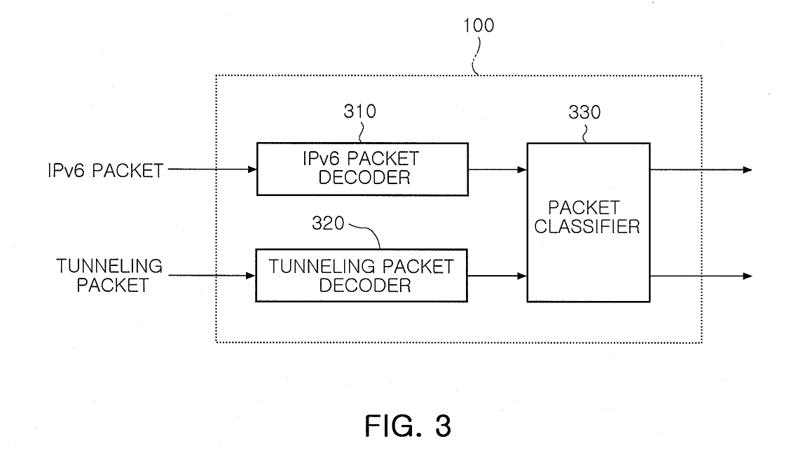

FIG. 3 is a view showing a configuration of a preprocessing unit 100 of an apparatus for detecting an attack packet in IPv6 according to an embodiment of the present invention. Referring to FIG. 3, the preprocessing unit 100 includes an IPv6 packet decoder 310, a tunneling packet decoder 320, and a packet classifier 330.

The IPv6 packet decoder 310 and the tunneling packet decoder 320 perform decoding through decomposing based on a standard protocol defined in RFC.

The packet classifier 330 divides the decoded IPv6 packet into a basic header, an extension header, a layer 4 (L4) protocol header, payload, and so on. The packet classifier 330 also divides the decoded tunneling packet into an IPv6 header and an IPv4 header. The decoding and dividing are performed to determine possibility of attack for each header and payload. The divided packet is sent to the attack determining unit 200 for determination of possibility of attack.

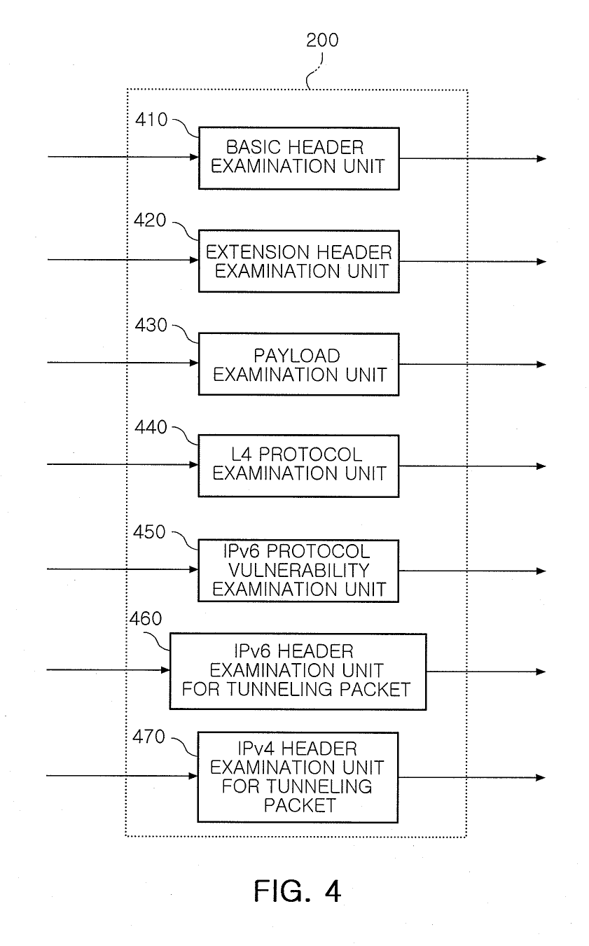

FIG. 4 is a view showing a configuration of an attack determining unit 200 of an apparatus for detecting an attack packet in IPv6 according to an embodiment of the present invention. Referring to FIG. 4, the attack determining unit 200 includes at least one of a basic header examination unit 410, an extension header examination unit 420, a payload examination unit 430, an L4 protocol examination unit 440, an IPv6 protocol vulnerability examination unit 450, an IPv6 header examination unit 460 for a tunneling packet, and an IPv4 header examination unit 470 for a tunneling packet. Each examination unit determines possibility of attack of the divided IPv6 and tunneling packets through pattern matching based on an attack determination rule set by the control unit 400.

The basic header examination unit 410 extracts source address information, destination address information, version information, next header information, and payload length information from the basic header received from the preprocessing unit 100, and determines whether the corresponding packet has possibility of attack from at least one piece of the extracted information. The extension header examination unit 420 extracts hop-by-hop extension header information, routing extension header information, fragment extension header information, destination extension header information, Internet protocol security protocol (IPsec) extension header information, and authentication extension header information from the extension header received from the preprocessing unit 100. Then, the extension header examination unit 420 determines whether the corresponding packet has possibility of attack by using at least one piece of the extracted information.

The payload examination unit 430 determines whether a payload field from the preprocessing unit 100 includes possibility of attack. The L4 protocol examination unit 440 determines whether a L4 protocol field of the corresponding packet includes possibility of attack by examining a transmission control protocol (TCP) header or user datagram protocol (UDP) header.

The IPv6 protocol vulnerability examining unit 450 detects an attack taking advantage of vulnerability of neighbor discovery protocol (NDP), duplicate address detection (DAD), and Internet control message protocol version 6 (ICMPv6), which occurs due to a configuration of protocol itself.

The IPv6 header examination unit 460 for a tunneling packet and the IPv4 header examination unit 470 for a tunneling packet respectively determine whether IPv6 and IPv4 headers have possibility of attack taking advantage of a transition technology from IPv4 to IPv6 such as Configuration tunnel, 6 to 4, 6over4, intra-site automatic tunnel addressing protocol (ISATAP), Teredo, and IPv6 over multi protocol label switching (MPLS), i.e., a dual stack transition mechanism. In general, since a tunneling packet in an IPv6 environment includes both an IPv6 header field and an IPv4 header field, the IPv6 header examination unit 460 and the IPv4 header examination unit 470 can separately perform the attack determination.

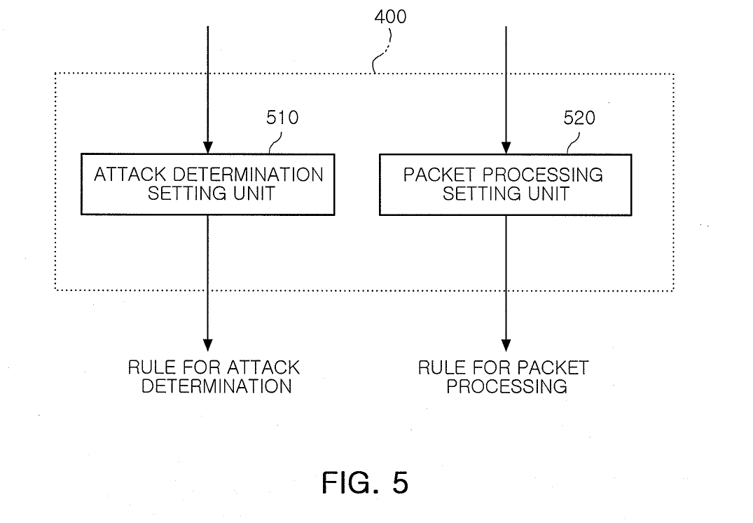

FIG. 5 is a view showing a configuration of a control unit 400 of an apparatus for detecting an attack packet in IPv6 according to an embodiment of the present invention. Referring to FIG. 5, the control unit 400 includes an attack determination setting unit 510 and a packet processing setting unit 520.

The attack determination setting unit 510 sets rules for detecting an attack packet, and sends information of a corresponding rule to the attack determining unit 200. The rule for detecting an attack packet can be adjusted flexibly in a setting of a manager or in a security system employing the present invention. Also, rules for determining an attack packet can be set by using information of a packet previously determined as an attack packet, which is stored in the traffic information storage unit 500, so that attack packets having similar characteristics can be detected and handled more quickly.

The packet processing setting unit 520 sets rules for processing an attack packet, and sends information of the corresponding rule to the packet processing unit 300. For example, a packet determined as an attack packet is filtered and/or deleted, and associated information is transmitted to the traffic information storage unit 500, so that the information can be used for the next packet. When an attack packet is detected, an intrusion alarm is generated so that a manager or a security system employing the present invention can properly cope with the attack packet. The rule can be set with reference to the information of an existing attack packet stored in the traffic information storage unit 500, so that processing of a specific packet can be adjusted.

In an apparatus and method for detecting an attack packet in IPv6 according to embodiments of the present invention, an IPv6 packet and a tunneling packet are examined for determination of possibility of attack, and a packet having possibility of attack is filtered and/or deleted, so that an attack packet can be detected and handled in IPv6.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for detecting an attack packet in
Internet Protocol version 6 (IPv6), comprising:
a control unit configured to set a rule for attack determination and a rule for processing of an attack packet;
a preprocessing unit configured to decode an IPv6 packet and a tunneling packet, and divide the decoded packet into each header and payload;
an attack determining unit configured to determine possibility of attack of the divided packet according to the rule for attack determination by using information of the divided packet, the rule being set at the control unit; and
a packet processing unit configured to perform at least one function of packet filtering, packet deleting, packet forwarding, and intrusion alarming according to a result of the determination of the attack determining unit, and the rule for processing of an attack packet, the rule being set at the control unit.

2. The apparatus of claim 1, further comprising a traffic information storage unit configured to store traffic information of a packet determined as an attack packet, so that the control unit can control the attack determining unit and the packet processing unit with reference to the information stored in the traffic information storage unit.

3. The apparatus of claim 1, wherein the preprocessing unit comprises:
an IPv6 packet decoder configured to decode an IPv6 packet;
a tunneling packet decoder configured to decode a tunneling packet; and
a packet classifier configured to divide the decoded packet into payload and each header.

4. The apparatus of claim 3, wherein the IPv6 packet decoder and the tunneling packet decoder perform decoding through decomposing based on a standard protocol defined in request for comments (RFC).

5. The apparatus of claim 3, wherein the packet classifier divides the decoded IPv6 packet into a basic header, extension headers, a layer 4 (L4) protocol header, and payload, and divides the decoded tunneling packet into an IPv6 header and an Internet Protocol version 4 (IPv4) header.

6. The apparatus of claim 5, wherein the attack determining unit comprises a basic header examination unit,
wherein the basic header examination unit is configured to determine whether the IPv6 packet is an attack packet by using at least one of source address information, destination address information, version information, next header information, and payload length information of the basic header.

7. The apparatus of claim 5, wherein the attack determining unit comprises an extension header examination unit,
wherein the extension header examination unit is configured to determine whether the IPv6 packet is an attack packet by using at least one of hop-by-hop extension header information, routing header information, fragment extension header information, destination extension header information, Internet Protocol security protocol (IPsec) extension header information, and authentication extension header information.

8. The apparatus of claim 5, wherein the attack determining unit comprises an L4 protocol examination unit,
wherein the L4 protocol examination unit is configured to determine whether the IPv6 packet is an attack packet by examining a transmission control protocol (TCP) header or user datagram protocol (UDP) header.

9. The apparatus of claim 5, wherein the attack determining unit comprises an IPv6 vulnerability examination unit,
wherein the IPv6 vulnerability examination unit is configured to detect an attack taking advantage of vulnerability of neighbor discovery protocol (NDP), duplicate address detection (DAD), and Internet control message protocol version 6 (ICMPv6).

10. The apparatus of claim 5, wherein the attack determining unit comprises an IPv6 header examining unit for a tunneling packet and an IPv4 header examining unit for a tunneling packet,
wherein the IPv6 header examining unit and the IPv4 header examining unit are configured to respectively examine an IPv6 header and an IPv4 header of the divided tunneling packet, and detect an attack taking advantage of a transition technology from IPv4 to IPv6, which is used in the corresponding packet, wherein
the transition technology is at least one of Configured tunnel, 6 to 4, 6over4, intra-site automatic tunnel addressing protocol (ISATAP), Teredo, and IPv6 over multi protocol label switching (MPLS).

11. The apparatus of claim 1, wherein the control unit comprises:
an attack determination setting unit configured to set a rule for detecting the attack packet, and send information of the rule for detecting the attack packet to the attack determining unit; and
a packet processing setting unit configured to set a rule for processing an attack packet, and send information of the rule for processing an attack packet to the packet processing unit.

12. A method for detecting an attack packet in Internet Protocol version 6 (IPv6), the method comprising:
setting a rule for attack determination, and a rule for processing of an attack packet;
decoding an IPv6 packet and a tunneling packet;
dividing the decoded packet into payload and each header;
determining possibility of attack of the divided packet according to the rule for attack determination by using information of the divided packet; and
performing at least one function of packet filtering, packet deleting, packet forwarding, and intrusion alarming according to a result of the determining of the possibility of attack and the set rule for processing an attack packet.

13. The method of claim 12, further comprising storing traffic information when it is determined that the corresponding packet has the possibility of attack, so that the traffic information can be used in the setting of the rule for attack determination, and the rule for processing of an attack packet.

14. The method of claim 12, wherein the decoding of the IPv6 packet and the tunneling packet comprises performing decoding through decomposing based on a standard protocol defined in request for comments (RFC).

15. The method of claim 12, wherein the dividing of the decoded packet comprises:
dividing the decoded IPv6 packet into a basic header, extension headers, a layer 4 (L4) protocol header, and payload; and
dividing the decoded tunneling packet into an IPv6 header and an IPv4 header.

16. The method of claim 15, wherein the determining of the possibility of attack comprises examining a basic header to determine whether the IPv6 packet is an attack packet by using at least one of source address information, destination address information, version information, network header information, and payload length information of the basic header.

17. The method of claim 15, wherein the determining of the possibility of attack comprises examining the extension headers to determine whether the packet is an attack packet by using at least one of hop-by-hop extension header information, routing extension header information, fragment extension header information, destination extension header information, Internet protocol security protocol (IPsec) extension header information, and authentication extension header information.

18. The method of claim 15, wherein the determining of the possibility of attack comprises examining a transmission control protocol (TCP) header or a user datagram protocol (UDP) header to determine whether the IPv6 packet is an attack packet.

19. The method of claim 15, wherein the determining of the possibility of attack comprises detecting an attack taking advantage of vulnerability of neighbor discovery protocol (NDP), duplicate address detection (DAD), and Internet control message protocol version 6 (ICMPv6).

20. The method of claim 15, wherein the determining of the possibility of attack comprises examining the IPv6 header and the IPv4 header of the tunneling packet to detect an attack taking advantage of a transition technology from IPv4 to IPv6, which is used in the corresponding packet, wherein
the transition technology is at least one of Configured tunnel, 6 to 4, 6over4, intra-site automatic tunnel addressing protocol (ISATAP), Teredo, and IPv6 over multi protocol label switching (MPLS).
